(19) United States
(12) Patent Application Publication
(10) Pub. No.: US 2015/0028722 A1
(43) Pub. Date: Jan. 29, 2015

(54) PIEZOELECTRIC ENERGY RECOVERY SYSTEM

(71) Applicant: Yao Hui, Shenzhen (CN)

(72) Inventor: Yao Hui, Shenzhen (CN)

(73) Assignee: AAC TECHNOLOGIES PTE. LTD., Singapore city (SG)

(21) Appl. No.: 14/191,786

(22) Filed: Feb. 27, 2014

(30) Foreign Application Priority Data
Jul. 25, 2013 (CN) 201310317926.9

(51) Int. Cl. H02N 2/18

(52) U.S. Cl. CPC H02N 2/186; H02N 2/181
USPC 310/319

(57) ABSTRACT

An energy recovery system for converting mechanical vibration to electric energy is disclosed. The system includes a case providing a plurality of sidewalls, a battery received in the case with a part of the battery positioned on one of the sidewalls of the case, and a number of piezoelectric energy collectors. Each of the collectors includes a cantilever capable of being activated to vibrate by the mechanical vibration. Electric current generated by deformation of the cantilever by virtue of the mechanical vibration is transmitted to the battery for recharging the battery.

### FIELD OF THE INVENTION

The present disclosure generally relates to a piezoelectric energy recovery system based on the conversed Piezoelectricity Effect, and also to a handheld device equipped with the energy recovery system.

### DESCRIPTION OF RELATED ART

It is well known that, the mechanical energy can produced when people are walking, running, jumping or do other activities. Furthermore, the piezoelectricity exists everywhere, and the pressure is also a kind of energy source. If a pressure is applied to a piezoelectric material, an electric potential difference will be generated (i.e., the piezoelectricity effect); and conversely, if a voltage is applied, a mechanical stress will be generated (i.e., the conversed piezoelectricity effect). If such energy that is ignored unconsciously can be collected and converted into electric energy for use, it will be beneficial to the society that suffers from a shortage of energy resources.

The present disclosure provides an energy recovery system to collect the electric energy which converted from the human beings' mechanical kinetic energy by use of the existing piezoelectric vibrators in handheld devices (i.e., mobile phones).

### BRIEF DESCRIPTION OF THE DRAWINGS

Many aspects of the embodiments can be better understood with reference to the following drawings. The components in the drawing are not necessarily drawn to scale, the emphasis instead being placed upon clearly illustrating the principles of the present disclosure. Moreover, in the drawings, like reference numerals designate corresponding parts throughout the several views.

FIG. 1 is a schematic block diagram illustrating a piezoelectric energy recovery system according to an exemplary embodiment of the present invention.

FIG. 2 is an exploded, isometric view of the piezoelectric energy recovery system of FIG. 1.

FIG. 3 is a schematic, isometric view of an energy collector of the piezoelectric energy recovery system of FIG. 2.

FIG. 4 is a top view of a piezoelectric module of the piezoelectric energy recovery system of FIG. 1.

FIG. 5 is an exploded, isometric view of a piezoelectric energy recovery system according to a second exemplary embodiment.

### DETAILED DESCRIPTION OF THE EXEMPLARY EMBODIMENTS

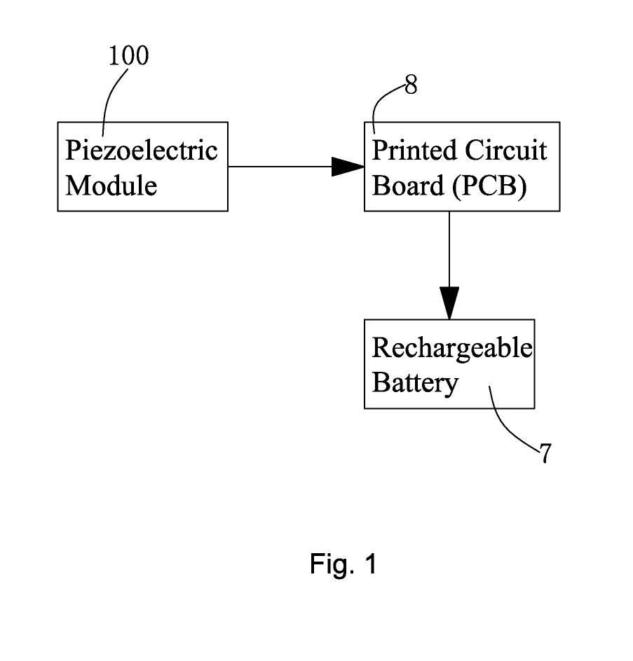

Referring to FIG. 1, a block diagram of a piezoelectric energy recovery system used in a handheld (i.e., mobile phones, PDA, panel computers or mobile powers) according to an exemplary embodiment of the present disclosure is shown. The piezoelectric energy recovery system includes a piezoelectric module 100, a rechargeable battery 7 and a PCB 8. Mechanical energy is generated through vibration of the piezoelectric module 100 and then converted to electric energy. Electric charges are input into the PCB 8, and then the electric charges are fed back into the battery 7 to replenish the electric energy.

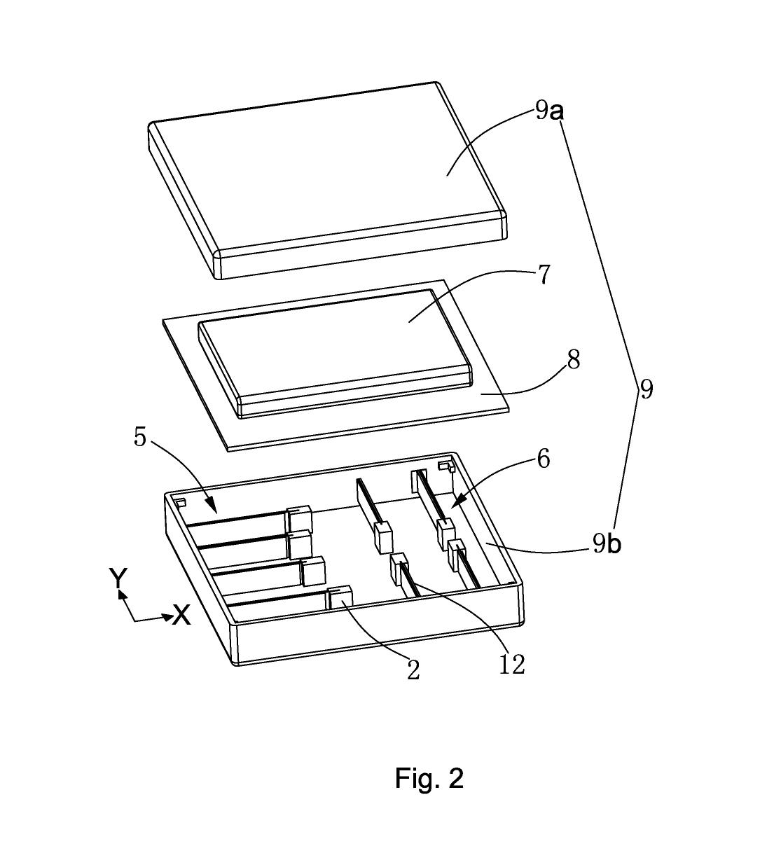

Referring to FIG. 2, in the preferred embodiment, the piezoelectric energy recovery system is a two-dimensional energy recovery system and further includes a first group energy collector 5, a second group energy collector 6, and a case 9. Each of the first and second group energy collectors 5, 6 includes a plurality of energy collectors 10 thereof. The case 9 includes an upper case 9a and a bottom case 9b. The first and second group energy collectors 5, 6 are respectively connected to the bottom case 9b, and then connected to the PCB 8. The first and second group energy collectors 5, 6 has a same height along the height direction of the bottom case 9b.

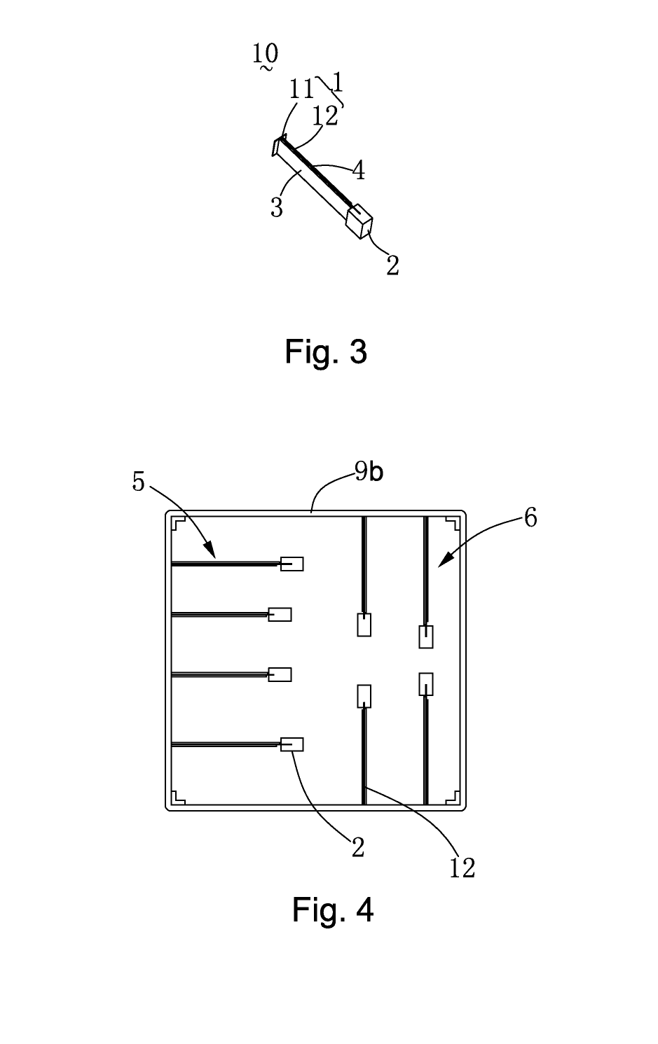

Referring to FIG. 3, each energy collector 10 includes a flexible metal plate 1, a counterweight block 2, a piezoelectric ceramics 3 and a damping pad 4. The metal plate 1 is T-shaped configuration and includes an upper plate 11 and a vibration arm 12 perpendicularly connected to the upper plate 11. The vibration arm 12 is positioned between the piezoelectric ceramics 3, and the damping pad 4. The upper plate 11 and the counterweight block 2 are respectively positioned on two opposite ends of the vibration arm 12.

The metal plate 1 is preferred to soft metal material, together with the appropriate counterweight block 2, can obtain a lower low-frequency resonant frequency and a wider frequency band. For a same quality of the energy collector 10, the density of the counterweight block 2 is greater, the volume of the energy collector 10 is smaller accordingly, thus the vibration efficiency of the energy collector 10 will be increased. Furthermore, the damping value of the damping pad 4 is appropriate so as to obtain a longer continuous band.

The piezoelectric ceramics 3 is adhered to a side of the vibration arm 12, the damping pad 4 is produced by damping rubber and positioned on the opposite side of the vibration arm 12. The metal plate 1, the counterweight block 2 and the piezoelectric ceramics 3 together forms a resonant system.

When a certain frequency load outside, with the corresponding frequency band to the resonant system, is applied to the resonant system, the vibration is converted to the vibration arm 12 via the upper plate 11, then the vibration arm 12 is driven to bend vibration, and the piezoelectric ceramics 3 is made to deform based on the conversed Piezoelectricity Effect, thereby electric energy can be achieved. The electric energy is inputted into the battery 7 by the PCB 8. By virtue of the Q value of the resonant system is too high, the damping pad 4 can be preferred to select the material with strong damping in order to expand the band of energy absorption.

Referring to FIG. 4, The plurality of energy collectors 10 of the first group energy collector 5 are arranged in a parallel line and spaced to each other. The plurality of energy collectors 10 of the second group energy collector 6 are collinearly arranged in pairs. In the preferred embodiment, the first group energy collector 5 has four energy collectors 10 formed in a parallel line, the second group energy collector 6 include a first pair and a second pair of energy collectors 10. The counterweight blocks 2 of the first energy collector 10 and the fourth energy collector 10 of the first group energy collector 5 are arranged in a line, while the counterweight blocks 2 of the second energy collector 10 and the third energy collector 10 of the first group collectors 5 are arranged in a line. The counterweight blocks 2 of the first and the fourth energy collectors 10 are spaced to the counterweight blocks 2 of the second and third energy collectors 10. Each pair energy collectors 10 have two energy collectors 10. The counterweight blocks 2 of the first pair energy collectors 10 are arranged between the second pair of energy collectors 10. The vibration direction of the vibration arm 12 of the first and second group energy collectors 5, 6 are coplanar and perpendicular to each other. That is to say, the first group energy collector 5 and the second group energy collector 6 are arrange at intervals from top to bottom of the bottom case 9b in turn via their respective upper plates 11.

The first group energy collector 5 is arranged in the bottom case 9b along the direction X shown in FIG. 2, while the second group energy collector 6 is arranged in the bottom case 9b along the perpendicular direction Y shown in FIG. 2. When the piezoelectric energy recovery system is moved along the direction X, the vibration arms 12 of the first group energy collector 5 are driven to vibrate. Similarly, when the piezoelectric energy recovery system is moved along the direction Y, the vibration arms 12 of the second group energy collector 6 are driven to vibrate. When the piezoelectric energy recovery system is moved along the 45 degree direction compare to the directions X, Y, the vibration arms 12 of the first and the second group energy collectors 5, 6 all are driven to vibrate. In the above conditions, the vibrating mechanical energy is converted by the piezoelectric ceramics 3 and the PCB 8 into the electric energy to charge the battery 7. Thus, the conversion and storage from the vibrating mechanical energy to the electric energy is achieved.

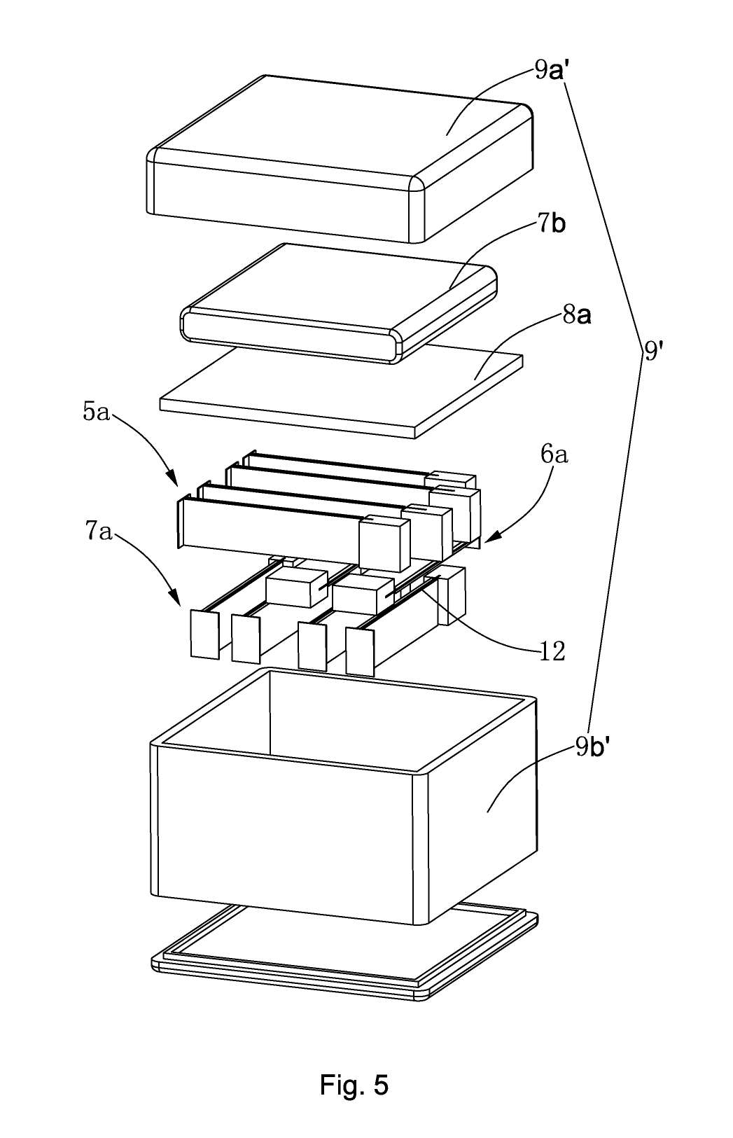

Referring to FIG. 5, a piezoelectric energy recovery system used in a handheld (i.e., mobile phones or mobile powers) according to a second exemplary embodiment of the present disclosure is shown. In this embodiment, the piezoelectric energy recovery system is a three-dimensional energy recovery system and further includes a third group energy collector 7a except including the first group and the second group energy collectors 5a, 6a, the battery 7b, the PCB 8a and the case 9′. The configuration of the first and second group energy collectors 5a, 6a, the battery 7b, the PCB 8a and the case 9′ are same as that of the first embodiment. In this embodiment, the third group energy collector 7a also includes a plurality of energy collectors. The first and second group energy collectors 5a, 6a both are arranged in the bottom case 9b′, while the third group energy collector 7a are arranged in the upper case 9a′.

The first, second, third group energy collectors 5a, 6a, 7a are arranged at intervals from top to bottom of the case 9′ in turn via their respective upper plates. The vibration directions of the vibration arms 12a of the first group energy collector 5a, the second group energy collector 6a and the third group energy collector 7a are respectively perpendicular to each other. Particularly, the second group energy collector 6a is positioned between the first group energy collector 5a and the third group energy collector 7a, and the energy collectors of the second group energy collectors 6a cannot connect the first and third group energy collectors 5a, 7a during the second group energy collector 6a in vibration. By virtue of the above configuration, the piezoelectric energy recovery system can vibrate along three mutually perpendicular directions in the three-dimensional cartesian coordinates to generate mechanical energy. Then the vibrating mechanical energy is converted by the piezoelectric ceramics and the PCB 8a into the electric energy to charge the battery 7b. Thus, the conversion and storage from the vibrating mechanical energy to the electric energy is achieved.

The present disclosure describes a handheld device using the piezoelectric energy recovery system. Indeed, the handheld device desired for enhanced battery endurance with such a piezoelectric energy recovery system set forth above can be mobile phones, PDA, mobile powers or panel computers.

The piezoelectric energy recovery system of the present disclosure amplifies the amplitude of vibration via the resonant, increasing the amplitude of vibration of the piezoelectric ceramics so that higher energy can be recovered. Furthermore, the damping pad expands the band of energy absorption, making the piezoelectric energy recovery system have a greater capacity to adapt to different use situations.

On the other hand, the present disclosure makes full use of the mechanical energy from the human being and the ambient environment to provide the handheld device as an important energy source. Furthermore, mechanical energy can be charged to batteries. As the batteries have currently become a bottleneck for handheld devices such as mobile phones, this is a very useful means to replenish the electric energy, and even in some outdoor special or severe environments, this can provide an important emergency electric power source for mobile phones.

On the third hand, the piezoelectric energy recovery system makes full use of the conversed piezoelectricity effect of the piezoelectric material so that a plurality of functions can be achieved by one component (i.e., the piezoelectric ceramics). This greatly saves the cost and does not need to change the system of the handheld devices (e.g., mobile phones) significantly, so it is easy to be achieved.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A piezoelectric energy recovery system, comprising:
a printed circuit board;
a rechargeable battery electrically connected to the printed circuit board;
a plurality of energy collectors electrically connected to the printed circuit board, each energy collector comprising:
a flexible metal plate having a vibration arm;
a counterweight block positioned on an end of the vibration arm of the flexible metal plate;
a piezoelectric ceramics positioned on a side of the vibration arm; wherein
mechanical energy is generated through vibration of the plurality of energy collectors and then converted to electric energy for being input into the printed circuit board and being fed back into the rechargeable battery to replenish the electric energy.

2. The piezoelectric energy recovery system of claim 1 being a two-dimensional energy recovery system and further comprising a first group energy collector and a second group energy collector, the first and second energy collectors respectively comprising the plurality of energy collectors, wherein, the vibration directions of the vibration arms of the first and second group energy collectors are coplanar and perpendicular to each other.

3. The piezoelectric energy recovery system of claim 2, wherein the plurality of energy collectors of the first group energy collectors are arranged in parallel lines and spaced to each other, and the plurality of energy collectors of the second group energy collectors are collinearly arranged in pairs, the counterweight blocks of each pair energy collectors of the second group energy collectors arranged between the parallel pair of energy collectors.

4. The piezoelectric energy recovery system of claim 2 further comprising a case connected to both the first group energy collector and the second group energy collector, and the first group energy collector and the second group energy collector is at a same height along the height direction of the case.

5. The piezoelectric energy recovery system of claim 1 being a three-dimensional energy recovery system, and further comprising a first group energy collector, a second group energy collector, and a third group energy collector, the first, second and third group energy collectors respectively comprising the plurality of collectors, and the vibration directions of the vibration arms of the first, second, and third group energy collectors respectively perpendicular to each other.

6. The piezoelectric energy recovery system of claim 5, wherein the first group energy collector, the second group energy collector, and the third group energy collector are arranged at intervals from top to bottom in turn.

7. The piezoelectric energy recovery system of claim 6, wherein the second group energy collector is positioned between the first group energy collector and the third group energy collector, and the energy collectors of the second group energy collector does not connect the first and third group energy collectors during vibration.

8. The piezoelectric energy recovery system of claim 1, wherein the metal plate further comprises an upper plate, the upper plate and the counterweight block positioned at two opposite ends of the vibration arm.

9. The piezoelectric energy recovery system of claim 8 further comprising a case, the plurality of energy collectors received in the case by the connection between the upper plate and the case.

10. The piezoelectric energy recovery system of claim 1, wherein each of the energy collectors further comprises a damping pad attached to the other side of the metal plate.

11. An energy recovery system for converting mechanical vibration to electric energy, comprising:
a case providing a plurality of sidewalls;
a battery received in the case with a part of the battery positioned on one of the sidewalls of the case;
a plurality of piezoelectric energy collectors, each of the collectors including a cantilever capable of being activated to vibrate by the mechanical vibration; wherein
the piezoelectric energy collectors are electrically connected to the battery, and electric current generated by deformation of the cantilever by virtue of the mechanical vibration is transmitted to the battery for recharging the battery.

12. The energy recovery system for converting mechanical vibration to electric energy of claim 11, wherein each of the piezoelectric energy collectors includes an upper plate positioned on the sidewall of the case and a counterweight block positioned at a distal end of the cantilever opposed to the upper plate.

13. The energy recovery system for converting mechanical vibration to electric energy of claim 11, wherein the cantilever of the piezoelectric energy collector includes a metal plate, a piezoelectric layer attached to one side of the metal plate.

14. The energy recovery system for converting mechanical vibration to electric energy of claim 13, wherein the cantilever of the piezoelectric energy collector further includes a damping plate attached to the other side of the metal plate.

15. The energy recovery system for converting mechanical vibration to electric energy of claim 1, wherein the piezoelectric energy collector includes a plurality of groups, and each group defines a vibration plane in which the cantilevers of the group vibrate, the vibration plane of one group being perpendicular to another group.
